(19) United States
(12) Patent Application Publication
(10) Pub. No.: US 2007/0019649 A1
(43) Pub. Date: Jan. 25, 2007

(54) Data transfer apparatus and data transfer method therefor

(75) Inventor: Shuji Komaki, Tokyo (JP)

Correspondence Address: Paul J. Esatto, Jr.;Scully, Scott, Murphy & Presser, 400 Garden City Plaza, Garden City, NY, 11530, US

(73) Assignee: NEC Corporation, Tokyo (JP)

(21) Appl. No.: 11/489,999

(22) Filed: Jul. 20, 2006

(30) Foreign Application Priority Data
Jul. 20, 2005 (JP) 209352/2005

(51) Int. Cl. H04L 12/56

(52) U.S. Cl. 370/392

(57) ABSTRACT

A data transfer apparatus includes at least one data processing section and a header information judgment section. The data processing section includes a process execution section and a header information assignment section. The header information judgment section judges the header information assigned to the data transmitted from the data processing section, and identifies the data processing section that has applied an erroneous process based on a result of the judgment.

### BACKGROUND OF THE INVENTION

1. Field of the Invention

The present invention relates to a data transfer apparatus and a data transfer method therefor, and more particularly, to a data transfer apparatus for applying various processes to inputted data, and to a data transfer method therefor.

2. Description of the Related Art

There are known data transfer apparatuses for transferring received data to another apparatus. Examples of the data transfer apparatuses include a packet data transfer apparatus. In general, when being transferred, packet data requires Various processes such as a protocol termination process. For this reason, the packet data transfer apparatus includes a plurality of processing blocks and employs a configuration where received data is sequentially processed in the processing blocks. Note that JP09-282166A, JP10-27155A, and JP10-171750A each disclose a configuration for implementing data transfer between the processing blocks.

In general, the data transfer apparatus checks, for example, a checksum to judge whether an error has occurred in inputted data. However, the packet data transfer apparatus, which employs a configuration where data is exchanged between the plurality of processing blocks, needs to judge whether an error has occurred in data to be outputted from the own apparatus, in addition to data to be inputted. This is because the packet data transfer apparatus has more complicated apparatus configuration and processes than the above-mentioned simple data transfer apparatus, and thus an error is more likely to occur in data in the packet data transfer apparatus.

However, the conventional data transfer apparatuses including those disclosed in the above-mentioned Patent Documents do not have means for judging whether an error has occurred in data to be outputted from the own apparatus. Thus, there is a fear that the conventional data transfer apparatuses may output defective data to another apparatus.

In addition, in recent years, due to high demands for reduction in size and cost of the data transfer apparatuses, circuit boards included therein are miniaturized and most functions are implemented in LSI chips. Accordingly, it is extremely difficult to identify a location where data is broken by using measurement hardware such as an oscilloscope. Therefore, there is increasing demand for a data transfer apparatus capable of easily identifying a location where an error has occurred.

### SUMMARY OF THE INVENTION

The present invention has been made to solve the above-mentioned problem. An exemplary feature of the present invention is to provide a data transfer apparatus capable of easily identifying a location where a data error has occurred in the apparatus and a data transfer method for the data transfer apparatus.

In a first aspect of the present invention, a data transfer apparatus includes at least one data processing section-includes a process execution section which applies a predetermined process to inputted data; and a header information assignment section which assigns header information unique to the data processing section, which applies the predetermined process, to the data to which the predetermined process is applied; and a header information judgment section which judges the header information assigned to the data transmitted from the data processing section, and which identifies a data processing section that applies an erroneous process based on a result of the judgment.

In a second aspect of the present invention, a data transfer method for a data transfer apparatus including at least one data processing section and a header information judgment section connected to an output side of the data processing section includes the steps of: applying a predetermined process to inputted data; assigning header information unique to the data processing section to the data to which the predetermined process is applied; judging the header information assigned to the data transmitted from the data processing section; and identifying a data processing section that applies an erroneous process based on a result of the judgment.

The data transfer apparatus according to the present invention includes a header information judgment section which judges the header information assigned to the data transmitted from the data processing section, and which identifies the data processing section that has applied an erroneous process based on a result of the judgment. Therefore, the data processing section in which an operation error has occurred can be easily identified.

### BRIEF DESCRIPTION OF THE DRAWINGS

The above and other objects, features and advantages of the present invention will become more apparent from the following detailed description when taken in conjunction with the accompanying drawings in which:

FIG. 1 is a block diagram of a data transfer system including a data transfer apparatus according to an embodiment of the present invention;

FIG. 2 is a block diagram of an example of a data processing section;

FIG. 3 is a block diagram of an example of a header information judgment section;

FIG. 4 is a flowchart of an operation example of the data transfer apparatus according to the embodiment of the present invention;

FIG. 5 is a block diagram of an example of the data transfer apparatus; and

FIG. 6 is a block diagram of an example of the data transfer system.

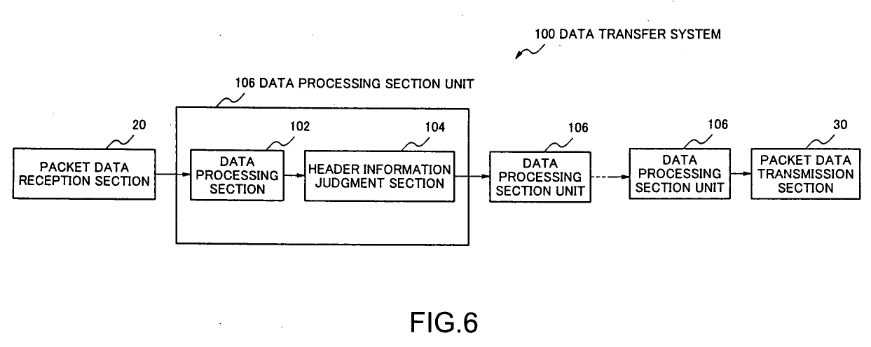

### DETAILED DESCRIPTION OF THE EXEMPLARY EMBODIMENTS

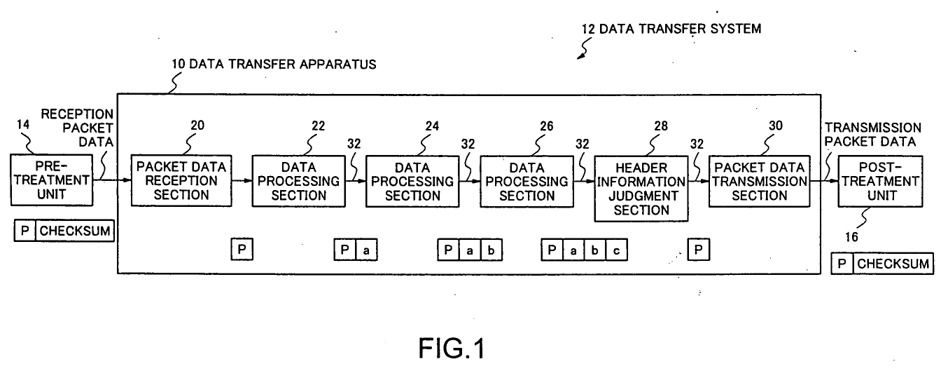

FIG. 1 shows a data transfer system 12 including a data transfer apparatus 10 according to an embodiment of the present invention. The data transfer system 12 includes a pre-treatment unit 14, the data transfer apparatus 10, and a post-treatment unit 16. The data transfer apparatus 10 applies a predetermined process to packet data received from the pre-treatment unit 14, and transmits the processed packet data to the post-treatment unit 16.

The data transfer apparatus 10 includes a packet data reception section 20, data processing sections 22, 24, and 26, a header information judgment section 28, and a packet data transmission section 30.

The packet data reception section 20 receives packet data from the pre-treatment unit 14 and checks a checksum of the received packet data to judge whether an error has occurred in the received packet data. Further, the packet data reception section 20 converts the received packet data into packet data having a format which can be handled by the data transfer apparatus 10 as needed. The packet data reception section 20 outputs the inputted packet data to the data processing section 22 when the inputted packet data is judged to have no error.

The packet data transmission section 30 transmits packet data to which a predetermined process has been applied in the data transfer apparatus 10, to the post-treatment unit 16. At this time, the packet data transmission section 30 calculates a checksum of the packet data to be finally outputted, and assigns the checksum to the packet data.

The data processing sections 22, 24, and 26 apply respective predetermined processes to packet data P received from the packet data reception section 20, and assign header information a, b, and c that are unique to the data processing sections 22, 24, and 26, respectively, to the packet data P to which the predetermined processes have been applied.

The header information judgment section 28 judges the header information a, b, and c assigned to the packet data P received from the data processing sections 22, 24, and 26, and performs a process based on a result of the judgment. Details of the process will be described later.

The data processing sections 22, 24, and 26 and the header information judgment section 28 are connected in series via interfaces 32. In this case, the packet data P is sequentially passed to the data processing section 22, the data processing section 24, the data processing section 26, and the header information judgment section 28, via the interfaces 32.

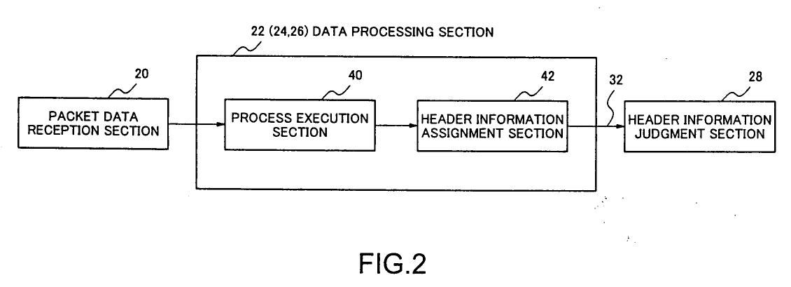

FIG. 2 is a block diagram of an example of the data processing sections 22, 24, and 26. The data processing sections 22, 24, and 26 each include a process execution section 40 and a header information assignment section 42. The process execution section 40 applies a predetermined process to packet data received from the packet data reception section 20, the data processing section 22, or the data processing section 24. The predetermined process can be a protocol header check process, a protocol termination process, a fragment process, a re-assembly process, or the like. The header information assignment section 42 assigns header information unique to each of the data processing sections 22, 24, and 26 to the packet data to which the predetermined process has been applied by the process execution section 40. Then, the header information assignment section 42 outputs the packet data having the header information to the data processing section 24, the data processing section 26, or the header information judgment section 28, via the interface 32.

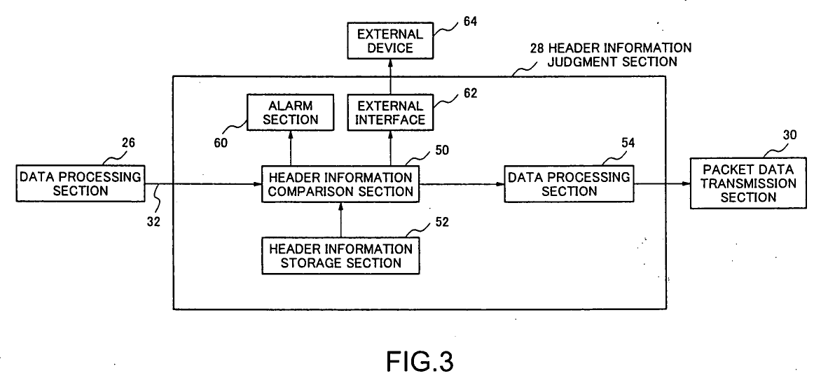

FIG. 3 is a block diagram of an example of the header information judgment section 28. The header information judgment section 28 includes a header information comparison section 50, a header information storage section 52, and a header information removing section 54.

The header information storage section 52 stores header information unique to the data processing sections 22, 24, and 26 in association with the data processing sections 22, 24, and 26, respectively. The header information can be changed to any value by using various access means.

The header information comparison section 50 extracts the header information of each of the data processing sections 22, 24, and 26 from the packet data having the header information received from the data processing section 26, which is the last data processing section. The header information comparison section 50 compares the extracted header information with the header information corresponding to each of the data processing sections 22, 24, and 26, which is stored in the header information storage section 52. When all pieces of the extracted header information match the corresponding pieces of the stored header information, the header information comparison section 50 judges that no data error has occurred in the data transfer apparatus 10. The header information comparison section 50 outputs the packet data having the header information to the header information removing section 54. On the other hand, when at least one piece of the extracted header information does not match the corresponding piece of the stored header information, the header information comparison section 50 judges that a data error has occurred in the data transfer apparatus 10. Then, the header information comparison section 50 discards the packet data, for example.

The header information removing section 54 removes the header information assigned to the packet data received from the header information comparison section 50, and outputs only the packet data to the packet data transmission section 30.

The header information comparison section 50 is connected to an alarm section 60 for informing a user operating the data transfer apparatus 10 of predetermined information, and to an external interface 62 for transmitting the predetermined information to an external device 64.

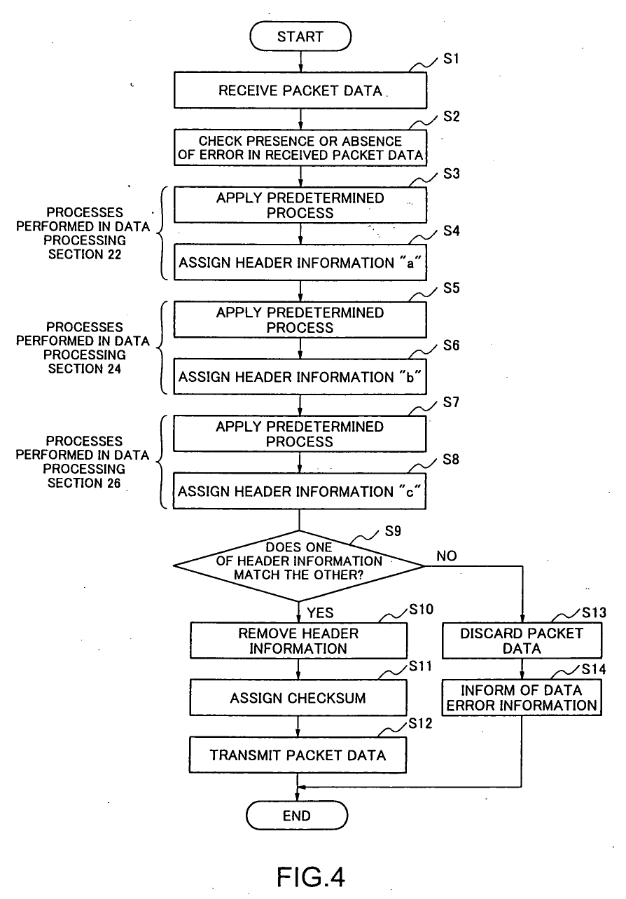

FIG. 4 is a flowchart showing an operation example of the data transfer apparatus 10 according to the embodiment of the present invention.

First, the packet data reception section 20 receives packet data P from the pre-treatment unit 14 (Step S1). The packet data reception section 20 checks a checksum to judge whether an error has occurred in the received packet data P (Step S2). When it is judged that no error has occurred in the received packet data P, the packet data P is inputted to the data processing section 22.

The process execution section 40 of the data processing section 22 applies a predetermined process to the inputted packet data P (Step S3). The header information assignment section 42 of the data processing section 22 assigns header information “a”, which is unique to the data processing section 22, to the packet data P to which the predetermined process has been applied (Step S4). The header information assignment section 42 outputs the packet data P assigned with the header information “a” to the data processing section 24 via the interface 32.

The process execution section 40 of the data processing section 24 applies a predetermined process only to the packet data P in the packet data P having the header information “a” inputted from the data processing section 22 (Step S5). The header information assignment section 42 of the data processing section 24 assigns the header information “b”, which is unique to the data processing section 24, to the packet data P to which the predetermined process has been applied (Step S6). Note that the already assigned header information “a” is kept as it is. The header information assignment section 42 outputs the packet data P assigned with the header information “a” and “b” to the data processing section 26 via the interface 32.

The process execution section 40 of the data processing section 26 applies a predetermined process only to the packet data P in the packet data P having the header information “a” and “b” inputted from the data processing section 24 (Step S7). The header information assignment section 42 of the data processing section 26 assigns the header information “c”, which is unique to the data processing section 26, to the packet data P to which the predetermined process has been applied (Step S8). Note that the already assigned header information “a” and “b” are kept as they are. The header information assignment section 42 outputs the packet data P assigned with the header information “a”, “b”, and “c” to the header information judgment section 28 via the interface 32.

The header information comparison section 50 of the header information judgment section 28 extracts the header information “a”, “b”, and “c” from the received packet data P having the header information “a”, “b”, and “c”. The header information comparison section 50 compares the extracted header information “a”, “b”, and “c” with the header information “a”, “b”, and “c” corresponding to the data processing sections 22, 24, and 26, respectively, which are stored in the header information storage section 52 (Step S9). When the extracted header information “a”, “b”, and “c” match the stored header information “a”, “b”, and “c”, respectively, the header information comparison section 50 judges that no data error has occurred in the data transfer apparatus 10. The header information comparison section 50 outputs the packet data P having the header information “a”, “b”, and “c” to the header information removing section 54. The header information removing section 54 removes the header information “a”, “b”, and “c” from the packet data P having the header information “a”, “b”, and “c” (Step S10). The header information removing section 54 transmits only the packet data P to the packet data transmission section 30. The packet data transmission section 30 calculates a checksum of the packet data P and assigns the checksum to the packet data P (Step S11). The packet data transmission section 30 transmits the packet data P having the checksum to the post-treatment unit 16 (Step S12).

On the other hand, in a case where at least one piece of the extracted header information “a”, “b”, and “c” does not match the corresponding piece of the header information “a”, “b”, or “c” stored in the header information storage section 52 (“No” in Step S9), the header information comparison section 50 judges that a data error has occurred in the data transfer apparatus 10. In this case, the header information comparison section 50 discards the packet data, for example (Step S13). In other words, the header information judgment section 28 does not transmit the packet data, which has a data error, to the post-treatment unit 16. Further, the header information comparison section 50 outputs disagreement of the header information and/or information for identifying which of the data processing sections 22, 24, and 26 has caused the disagreement of the header information, to the alarm section 60 or the external interface 62 (Step S14). With this configuration, the user of the data transfer apparatus 10 or a remote user thereof can be informed of the occurrence of a data error in the data transfer apparatus 10. Further, the user can be informed of which of the data processing sections 22, 24, and 26 has caused the error in the data transfer apparatus 10.

As described above, the data transfer apparatus 10 according to the embodiment of the present invention includes at least one of the data processing sections 22, 24, and 26 which assigns unique header information to the packet data to which a predetermined process has been applied. Further, the data transfer apparatus 10 includes the header information judgment section 28 for judging the header information assigned to the packet data received from the data processing sections 22, 24, and 26, and for identifying the data processing section that has applied an erroneous process based on a result of the judgment. Therefore, it is easy to identify which of the data processing sections 22, 24, and 26 has caused an operation error. For example, it is assumed that each of the data processing sections 22, 24, and 26 is configured by a separate LSI chip. According to the above-described embodiment, although it is impossible to identify which circuit in the LSI chip has an error, it is possible to identify at least which LSI chip has an error. Thus, for example, by replacing the LSI chip of the data processing section 22, 24, or 26 that may have an operation error, the data transfer apparatus 10 can be swiftly and easily restored to a normal state.

The header information judgment section 28 of the data transfer apparatus 10 can discard the packet data based on a result of the header information judgment. Therefore, the data transfer apparatus 10 does not output packet data having a data error to another apparatus.

Note that the number of the data processing sections 22, 24, and 26 is not limited to three.

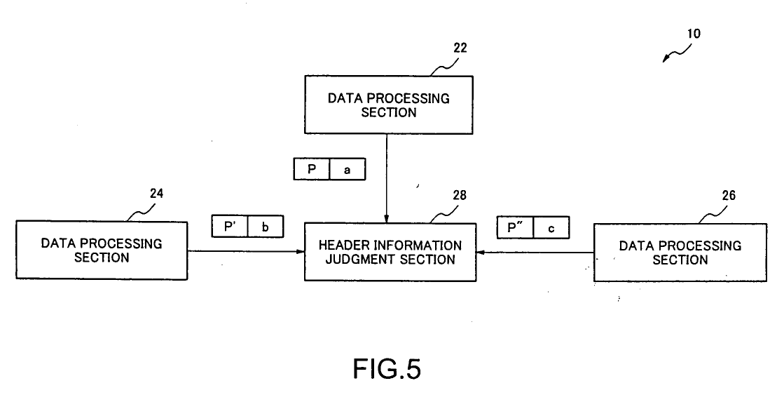

Further, the data transfer apparatus 10 may employ a star connection, in which the data processing sections 22, 24, and 26 are connected to the header information judgment section 28 in parallel, as shown in FIG. 5. In this case, the header information judgment section 28 receives packet data P to which the header information “a” is assigned from the data processing section 22, receives packet data P′ to which the header information “b” is assigned from the data processing section 24, and receives packet data P″ to which the header information “c” is assigned from the data processing section 26. The header information judgment section 28 judges whether correct header information is received from each of the data processing sections 22, 24, and 26, and transmits or discards the packet data P, P′, and P″ based on a result of the judgment.

Further, the data transfer system 12 may be replaced with a data transfer system 100 in which data processing section units 106, 106, . . . each including at least one data processing section 102 and a header information judgment section 104 are connected in series.

While this invention has been described in connection with certain exemplary embodiments, it is to be understood that the subject matter encompassed by way of this invention is not to be limited to those specific embodiments. On the contrary, it is intended for the subject matter of the invention to include all alternatives, modifications and equivalents as can be included within the spirit and scope of the following claims.

Further, it is the inventor's intent to retain all equivalents of the claimed invention even if the claims are amended during prosecution.

What is claimed is:

1. A data transfer apparatus, comprising:
at least one data processing section comprising:
a process execution section which applies a predetermined process to inputted data; and
a header information assignment section which assigns header information unique to the data processing section, which applies the predetermined process, to the data to which the predetermined process is applied; and
a header information judgment section which judges the header information assigned to the data transmitted from the data processing section, and which identifies a data processing section that applies an erroneous process based on a result of the judgment.

2. A data transfer apparatus according to claim 1, wherein the header information judgment section comprises:
a header information storage section which stores the header information corresponding to the data processing section; and
a header information comparison section which compares the header information assigned to the data transmitted from the data processing section with the header information corresponding to the data processing section, which is stored in the header information storage section.

3. A data transfer apparatus according to claim 2, wherein the header information comparison section discards the transmitted data when one of the compared header information does not match the other.

4. A data transfer apparatus according to claim 2, wherein the header information judgment section further comprises an alarm section which informs the comparison result to an outside.

5. A data transfer apparatus according to claim 4, wherein the comparison result is informed to the outside via the alarm section when one of the compared header information is different from the other.

6. A data transfer apparatus according to claim 4, wherein the comparison result includes information for identifying the data processing section that applies the erroneous process.

7. A data transfer apparatus according to claim 1, wherein the header information judgment section comprises a header information removing section which removes the header information assigned to the transmitted data.

8. A data transfer apparatus according to claim 1, wherein a plurality of data processing sections and the header information judgment section are connected in series.

9. A data transfer apparatus according to claim 1, wherein a plurality of data processing sections are connected the header information judgment section in parallel.

10. A data transfer apparatus according to claim 1, wherein a plurality of pairs of the data processing section and the header information judgment section are connected in series.

11. A data transfer method for a data transfer apparatus including at least one data processing section and a header information judgment section connected to an output side of the data processing section, the method comprising the steps of:
applying a predetermined process to inputted data;
assigning header information unique to the data processing section to the data to which the predetermined process is applied;
judging the header information assigned to the data transmitted from the data processing section; and
identifying a data processing section that applies an erroneous process based on a result of the judgment.

12. A data transfer method according to claim 11, wherein the step of judging the header information is carried out by comparing the header information assigned to the data transmitted from the data processing section with the header information corresponding to the data processing section, which is stored in the header information judgment section.

13. A data transfer method according to claim 12, further comprising the step of discarding the transmitted data when one of the compared header information does not match the other.

14. A data transfer method according to claim 12, further comprising the step of transmitting the transmitted data to another apparatus when one of the compared header information match the other.

15. A data transfer method according to claim 12, further comprising the step of informing a comparison result to an outside when one of the compared header information does not match the other.

16. A data transfer method according to claim 15, wherein the comparison result to be informed includes information for identifying the data processing section that has applied the erroneous process.

17. A data transfer method according to claim 12, further comprising the step of removing the header information assigned to the transmitted data.
